(19) United States
(12) Patent Application Publication
(10) Pub. No.: US 2025/0069245 A1
(43) Pub. Date: Feb. 27, 2025

(54) MONOCULAR IMAGE DEPTH ESTIMATION METHOD AND APPARATUS, AND COMPUTER DEVICE

(71) Applicant: ZHEJIANG LAB, Hangzhou (CN)

(72) Inventors: Qibo QIU, Hangzhou (CN); Wei HUA, Hangzhou (CN); Haiming GAO, Hangzhou (CN)

(21) Appl. No.: 18/518,959

(22) Filed: Nov. 25, 2023

Related U.S. Application Data
(63) Continuation of application No. PCT/CN2023/121043, filed on Sep. 25, 2023.

(30) Foreign Application Priority Data
Aug. 21, 2023 (CN) 202311050584.9

(51) Int. Cl. G06T 7/55; G06T 3/40; G06T 7/70; G06T 7/80; G06V 10/44

(52) U.S. Cl. CPC G06T 7/55; G06T 3/40; G06T 7/70; G06T 7/80; G06V 10/44; G06T 2207/10028

(57) ABSTRACT

A monocular image depth estimation method and apparatus, and a computer device are provided. The method includes: obtaining a first depth map of a to-be-estimated image; obtaining a dynamic point set and a first pose transformation result of a to-be-estimated millimeter-wave point cloud; obtaining a second depth map of a latter frame of the to-be-estimated image; calculating a projection error between a first depth map and the second depth map of the latter frame of the to-be-estimated image; obtaining a second pose transformation result of the to-be-estimated millimeter-wave point cloud; obtaining a pose estimation error; calculating a depth error of a moving object in two frames of the to-be-estimated image; and obtaining an overall training loss, obtaining a complete depth estimation model, and performing monocular image depth estimation on the to-be-estimated image.

### CROSS REFERENCE TO RELATED APPLICATIONS

This application is a Continuation of PCT Patent Application No. PCT/CN2023/121043, entitled “MONOCULAR IMAGE DEPTH ESTIMATION METHOD AND APPARATUS, AND COMPUTER DEVICE”, filed on Sep. 25, 2023; which claims priority to Chinese Patent Application No. 202311050584.9, entitled “MONOCULAR IMAGE DEPTH ESTIMATION METHOD AND APPARATUS, AND COMPUTER DEVICE” and filed on Aug. 21, 2023, the entire contents of which are incorporated herein by reference.

### TECHNICAL FIELD

The present disclosure relates to the field of image processing technologies, and in particular, to a monocular image depth estimation method and apparatus, and a computer device.

### BACKGROUND

Three-dimensional environment perception is an important technology in the field of mobile robots and unmanned vehicles. However, current three-dimensional environment perception mainly relies on expensive and dense lidar to acquire accurate three-dimensional information of an environment. Compared with the acquisition of the accurate three-dimensional information of the environment through the dense lidar, self-supervised monocular image depth estimation perceives a depth of the environment through an image captured by a camera and does not rely on any additional depth marker, which has certain cost advantages.

However, estimating a depth directly from an image is an ill-posed problem, and by use of a mainstream deep learning method, an absolute depth of the image cannot be estimated accurately only from the image captured by the camera. Therefore, in the related art, an image depth estimation capability is enhanced by introducing additional cheap modal data. Specifically, depth estimation may be assisted by introducing Global Positioning System (GPS) coordinates, Inertial Measurement Unit (IMU) data, or sparse lidar data. However, assisting the depth estimation by introducing the GPS coordinates, the IMU data, or the sparse lidar data requires removing a moving object in the image and relies on a static environment assumption. As a result, depth estimation results of two adjacent frames of monocular images with the moving object jitter greatly, and stability of the depth estimation results of the image cannot be guaranteed.

The problem in the related art that the stability of the depth estimation results of the image cannot be guaranteed has not yet been solved.

### SUMMARY

According to various embodiments of the present disclosure, a monocular image depth estimation method and apparatus, and a computer device are provided.

In a first aspect, the present disclosure provides a monocular image depth estimation method. The method includes the following steps:
performing, by using a preset initial depth estimation model, depth estimation on two frames of a to-be-estimated image, to obtain a first depth map of the to-be-estimated image; the first depth map of the to-be-estimated image including a first depth map of a former frame of the to-be-estimated image and a first depth map of a latter frame of the to-be-estimated image;
performing, by using a preset initial point cloud estimation model, point cloud estimation on two frames of a to-be-estimated millimeter-wave point cloud corresponding to the two frames of the to-be-estimated image, to obtain a dynamic point set and a first pose transformation result of the to-be-estimated millimeter-wave point cloud;
calculating an external parameter transformation value of a camera based on the first pose transformation result; projecting the first depth map of the former frame of the to-be-estimated image to a viewing angle of the latter frame of the to-be-estimated image based on the external parameter transformation value of the camera and an internal parameter value of the camera, to obtain a second depth map of the latter frame of the to-be-estimated image; and calculating a projection error between the first depth map of the latter frame of the to-be-estimated image and the second depth map of the latter frame of the to-be-estimated image according to a preset projection error calculation manner;
performing, by using a preset estimation algorithm, overall pose transformation estimation on the two frames of the to-be-estimated millimeter-wave point cloud, to obtain a second pose transformation result of overall pose transformation of the to-be-estimated millimeter-wave point cloud; and obtaining a pose estimation error between the first pose transformation result and the second pose transformation result based on the first pose transformation result and the second pose transformation result according to a preset pose estimation error calculation manner;
calculating a depth error of a moving object in the two frames of the to-be-estimated image based on the first depth map and the dynamic point set according to a preset moving object depth error calculation manner;
obtaining an overall training loss of the to-be-estimated image according to the projection error between the first depth map of the latter frame of the to-be-estimated image and the second depth map of the latter frame of the to-be-estimated image, the pose estimation error between the first pose transformation result and the second pose transformation result, and the depth error of the moving object in the two frames of the to-be-estimated image, and training the initial depth estimation model and the initial point cloud estimation model by using the overall training loss, until the initial depth estimation model and the initial point cloud estimation model converge, to obtain a complete depth estimation model for monocular image depth estimation; and
performing monocular image depth estimation on the to-be-estimated image based on the complete depth estimation model.

In an embodiment, prior to the performing, by using the preset initial depth estimation model, depth estimation on the two frames of the to-be-estimated image, to obtain the first depth map of the to-be-estimated image, the method further includes the following steps:
performing an operation of subtracting a mean value and dividing by a variance on two frames of a to-be-estimated original image to generate two frames of a first image; and
scaling the two frames of the first image to a preset size by using a preset scaling method, to obtain the two frames of the scaled to-be-estimated image.

In an embodiment, the performing, by using the preset initial depth estimation model, depth estimation on the two frames of the to-be-estimated image, to obtain the first depth map of the to-be-estimated image includes the following steps:
acquiring depth features of the to-be-estimated image by using a depth encoding network of the preset initial depth estimation model;
performing depth estimation-related feature extraction on the acquired depth features by using a depth decoding network of the preset initial depth estimation model, to obtain an inverse depth map of the to-be-estimated image; and
performing reciprocal processing on the inverse depth map to obtain the first depth map of the to-be-estimated image.

In an embodiment, the performing, by using the preset initial point cloud estimation model, point cloud estimation on the two frames of the to-be-estimated millimeter-wave point cloud corresponding to the two frames of the to-be-estimated image, to obtain the dynamic point set and the first pose transformation result of the to-be-estimated millimeter-wave point cloud includes the following steps:
acquiring a scene flow of the to-be-estimated millimeter-wave point cloud by using a scene flow prediction network of the preset initial point cloud estimation model;
screening out, according to a preset dynamic point screening condition, dynamic points in the scene flow whose translation offsets are greater than or equal to one times a variance of an average translation offset, to obtain the dynamic point set of the to-be-estimated millimeter-wave point cloud;
acquiring a matrix with one row and six columns of the to-be-estimated millimeter-wave point cloud by using a pose estimation network of the preset initial point cloud estimation model; and
converting the matrix with one row and six columns into a matrix with three rows and four columns by using a preset rotation formula, to obtain the first pose transformation result of the to-be-estimated millimeter-wave point cloud.

In an embodiment, the calculating the external parameter transformation value of the camera based on the first pose transformation result; projecting the first depth map of the former frame of the to-be-estimated image to the viewing angle of the latter frame of the to-be-estimated image based on the external parameter transformation value of the camera and the internal parameter value of the camera, to obtain the second depth map of the latter frame of the to-be-estimated image includes the following steps:
obtaining the external parameter transformation value of the camera corresponding to the two frames of the to-be-estimated image based on the first pose transformation result and a preset external parameter value from millimeter-wave radar to the camera;
projecting the first depth map of the former frame of the to-be-estimated image to the viewing angle of the latter frame of the to-be-estimated image based on the external parameter transformation value of the camera and the internal parameter value of the camera, to obtain the second depth map of the latter frame of the to-be-estimated image based on a projection result.

In an embodiment, a calculation formula of the projection error L₁ between the first depth map of the latter frame of the to-be-estimated image and the second depth map of the latter frame of the to-be-estimated image is:

$${L}_{1} = \frac{\partial }{2} ( 1 - SSIM ( {D}_{T} , {D}_{T - 1 \to T} ) ) + ( 1 - \partial ) {‖ {D}_{T} - {D}_{T - 1 \to T} ‖}_{1}$$

where D_{T} denotes a first depth map of the to-be-estimated image at time T, D_{T-1→T} denotes a second depth map of the to-be-estimated image at time T obtained by projecting a first depth map of the to-be-estimated image at time T−1 to a viewing angle of the to-be-estimated image at time T, Structure Similarity Index Measure (SSIM) denotes a loss of a projection error, and ∂ denotes a preset parameter.

In an embodiment, the performing, by using the preset estimation algorithm, overall pose transformation estimation on the two frames of the to-be-estimated millimeter-wave point cloud, to obtain the second pose transformation result of overall pose transformation of the to-be-estimated millimeter-wave point cloud includes:
performing, by using an Iterative Closest Point (ICP) algorithm, overall pose transformation estimation on the two frames of the to-be-estimated millimeter-wave point cloud, to obtain the second pose transformation result of overall pose transformation of the to-be-estimated millimeter-wave point cloud.

In an embodiment, a calculation formula of the pose estimation error L₂ between the first pose transformation result and the second pose transformation result is:

$${L}_{2} = {‖ {TR}_{1} - {TR}_{2} ‖}_{2}^{2}$$

where TR₁ denotes the first pose transformation result, and TR₂ denotes the second pose transformation result.

In an embodiment, a calculation formula of the depth error L₃ of the moving object in the two frames of the to-be-estimated image is:

$${L}_{3} = {\sum }_{p ∈ {RD}_{T} , q ∈ {RD}_{T - 1}} Sim ( p , q ) \cdot$$

$$π ( cos ( {Loc}_{q} , {TR}_{T - 1 \to T} [ : , 3 ] ) ) \cdot π ( {D}_{T} ( p ) < {D}_{T - 1} ( q ) )$$

where RD_{T-1} denotes a dynamic point set at time T−1, RD_{T} denotes a dynamic point set at time T, p and q denotes any point pair in RD_{T-1} and RD_{T}, Sim (p,q) denotes a probability that p and q are from a same obstacle, π(cos(Loc_{q}, TR_{T-1→T}[:,3])) denotes an indicator function, Loc_{q} denotes three-dimensional space coordinates of a point q, TR_{T-1→T} denotes a first pose transformation result of the to-be-estimated millimeter-wave point cloud from time T−1 to time T, π(D_{T}(p)<D_{T-1}(q)) denotes an indicator function, D_{T}(p) denotes a depth value of p in a first depth map of the to-be-estimated image at time T, and D_{T-1}(q) denotes a depth value of q in a first depth map of the to-be-estimated image at time T−1.

In an embodiment, a formula of the overall training loss L of the to-be-estimated image is:

$$L = {L}_{1} + β \cdot {L}_{2} + ( 1 - β ) \cdot {L}_{3}$$

where

$$β = 1 - \frac{ep}{Max\_epoch} ,$$

ep denotes a current training round, and Max_epoch denotes a maximum training round.

In a second aspect, the present disclosure provides a monocular image depth estimation apparatus. The apparatus includes: a depth estimation module, a point cloud estimation module, a first calculation module, a second calculation module, a third calculation module, a training module, and an estimation module.

The depth estimation module is configured to perform, by using a preset initial depth estimation model, depth estimation on two frames of a to-be-estimated image, to obtain a first depth map of the to-be-estimated image; the first depth map of the to-be-estimated image including a first depth map of a former frame of the to-be-estimated image and a first depth map of a latter frame of the to-be-estimated image.

The point cloud estimation module is configured to perform, by using a preset initial point cloud estimation model, point cloud estimation on two frames of a to-be-estimated millimeter-wave point cloud corresponding to the two frames of the to-be-estimated image, to obtain a dynamic point set and a first pose transformation result of the to-be-estimated millimeter-wave point cloud.

The first calculation module is configured to calculate an external parameter transformation value of a camera based on the first pose transformation result; project the first depth map of the former frame of the to-be-estimated image to a viewing angle of the latter frame of the to-be-estimated image based on the external parameter transformation value of the camera and an internal parameter value of the camera, to obtain a second depth map of the latter frame of the to-be-estimated image; and calculate a projection error between the first depth map of the latter frame of the to-be-estimated image and the second depth map of the latter frame of the to-be-estimated image according to a preset projection error calculation manner.

The second calculation module is configured to perform, by using a preset estimation algorithm, overall pose transformation estimation on the two frames of the to-be-estimated millimeter-wave point cloud, to obtain a second pose transformation result of overall pose transformation of the to-be-estimated millimeter-wave point cloud; and obtain a pose estimation error between the first pose transformation result and the second pose transformation result based on the first pose transformation result and the second pose transformation result according to a preset pose estimation error calculation manner.

The third calculation module is configured to calculate a depth error of a moving object in the two frames of the to-be-estimated image based on the first depth map and the dynamic point set according to a preset moving object depth error calculation manner.

The training module is configured to obtain an overall training loss of the to-be-estimated image according to the projection error between the first depth map of the latter frame of the to-be-estimated image and the second depth map of the latter frame of the to-be-estimated image, the pose estimation error between the first pose transformation result and the second pose transformation result, and the depth error of the moving object in the two frames of the to-be-estimated image, and train the initial depth estimation model and the initial point cloud estimation model by using the overall training loss, until the initial depth estimation model and the initial point cloud estimation model converge, to obtain a complete depth estimation model for monocular image depth estimation.

The estimation module is configured to perform monocular image depth estimation on the to-be-estimated image based on the complete depth estimation model.

In a third aspect, the present disclosure further provides a computer device. The computer device includes a memory and a processor, the memory storing a computer program, wherein the processor, when executing the computer program, implements steps of the monocular image depth estimation method in the above first aspect.

Details of one or more embodiments of the present disclosure are set forth in the following accompanying drawings and descriptions. Other features, objectives, and advantages of the present disclosure will become obvious with reference to the specification, the accompanying drawings, and the claims.

### BRIEF DESCRIPTION OF THE DRAWINGS

In order to more clearly illustrate the technical solutions in embodiments of the present disclosure or the conventional art, the accompanying drawings used in the description of the embodiments or the conventional art will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a structural block diagram of hardware of a terminal of a monocular image depth estimation method according to some embodiments;

FIG. 2 is a flowchart of a monocular image depth estimation method according to some embodiments;

FIG. 3 is a flowchart of a monocular image depth estimation method according to some embodiments;

FIG. 4 is a structural block diagram of a monocular image depth estimation apparatus according to some embodiments; and

FIG. 5 is a structural block diagram of a computer device according to some embodiments.

### DETAILED DESCRIPTION OF THE EMBODIMENTS

The technical solutions in the embodiments of the present disclosure will be described clearly and completely below with reference to the accompanying drawings in the embodiments of the present disclosure. Apparently, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

Unless defined otherwise, all technical and scientific terms as referred to in the present disclosure have the same meanings as would generally understood by those skilled in the technical field of the present disclosure. In the present disclosure, “a/an”, “one”, “the”, “these”, and other similar words do not indicate a quantitative limitation, which may be singular or plural. The terms such as “comprise”, “include”, “have”, and any variants thereof as referred to in the present disclosure are intended to cover a non-exclusive inclusion, for example, processes, methods, systems, products, or devices including a series of steps or modules (units) are not limited to these steps or modules (units) listed, and may include other steps or modules (units) not listed, or may include other steps or modules (units) inherent to these processes, methods, systems, products, or devices. Words such as “connect”, “join”, and “couple” as referred to in the present disclosure are not limited to physical or mechanical connections, but may include electrical connections, whether direct or indirect. “A plurality of” as referred to in the present disclosure means two or more. “And/or” describes an association relationship between associated objects, indicating that three relationships may exist. For example, A and/or B indicates that there are three cases of A alone, A and B together, and B alone. Generally, the character “/” indicates an “or” relationship between the associated objects. The terms “first”, “second”, “third”, and the like as referred to in the present disclosure only distinguish similar objects and do not represent specific ordering of the objects.

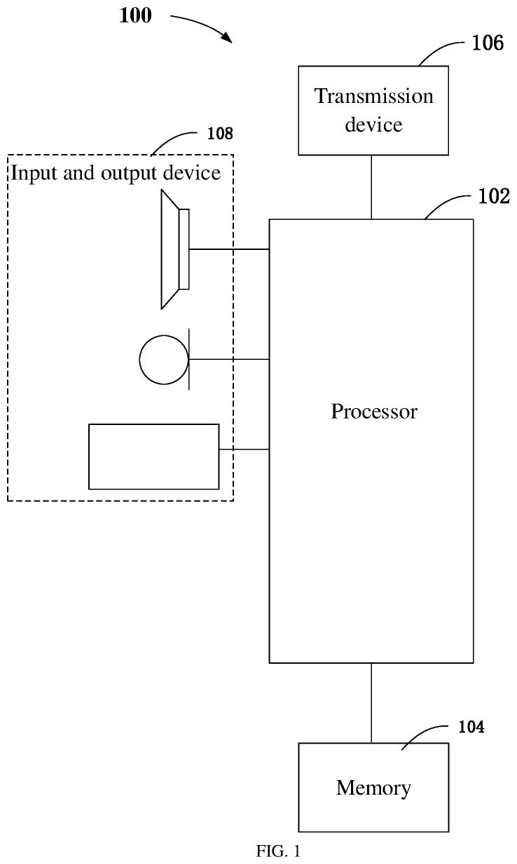

Method embodiments provided in this embodiment may be performed in a terminal, a computer, or a similar computing apparatus. For example, the method is executed in a mobile terminal. FIG. 1 is a structural block diagram of hardware of a terminal 100 of a monocular image depth estimation method according to some embodiments. As shown in FIG. 1, the terminal 100 may include one or more (only one is shown in FIG. 1) processors 102 and a memory 104 for storing data. The processor 102 may include, but is not limited to, processing apparatuses such as a Microcontroller Unit (MCU) and a Field Programmable Gate Array (FPGA). The above terminal 100 may further include a transmission device 106 for a communication function and an input and output device 108. Those of ordinary skill in the art should know that the structure shown in FIG. 1 is only schematic and not intended to limit the structure of the terminal 100. For example, the terminal 100 may alternatively include more or fewer components than those shown in FIG. 1, or has a configuration different from that in FIG. 1.

The memory 104 may be configured to store a computer program, for example, a software program and module of application software, such as a computer program corresponding to the monocular image depth estimation method in this embodiment. The processor 102 runs the computer program stored in the memory 104, thereby executing various functional applications and data processing, namely, implementing the above method. The memory 104 may include a high-speed random access memory and may also include a non-transitory memory, for example, one or more magnetic storage apparatuses, flash memories, or other non-transitory solid-state memories. In some examples, the memory 104 may further include memories remotely arranged relative to the processor 102, and these remote memories may be connected to the terminal 100 over a network. Examples of the networks include, but are not limited to, the Internet, the Intranet, a local area network, a mobile communication network, and a combination thereof.

The transmission device 106 is configured to receive or send data over a network. The network includes a wireless network provided by a communication provider of the terminal 100. In an example, the transmission device 106 includes a Network Interface Controller (NIC), which may be connected with other network devices through a base station, thereby communicating with the Internet. In an example, the transmission device 106 may be a Radio Frequency (RF) module, which is configured to communicate with the Internet in a wireless manner.

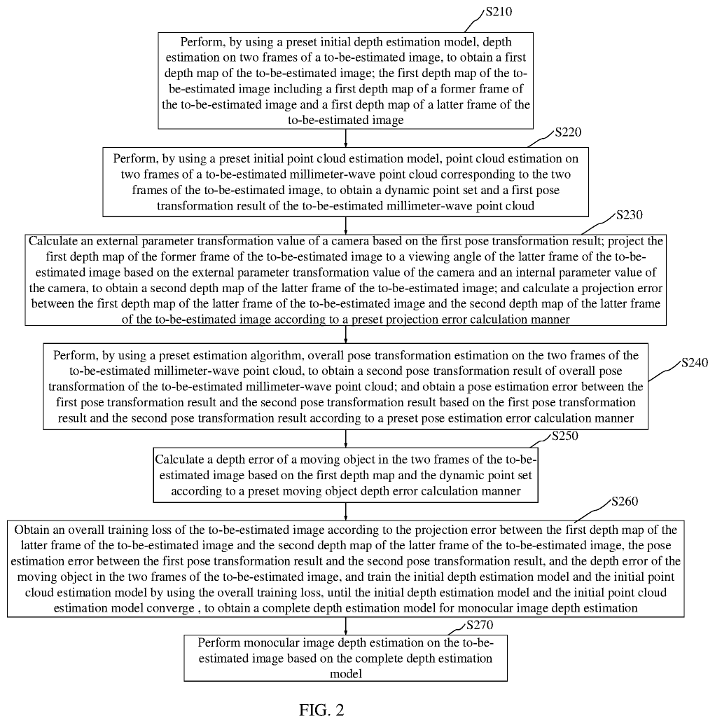

In this embodiment, a monocular image depth estimation method is provided. FIG. 2 is a flowchart of the monocular image depth estimation method in this embodiment. As shown in FIG. 2, the process includes steps S210 to step S270 as follows.

In step S210, depth estimation is performed on two frames of a to-be-estimated image by using a preset initial depth estimation model, to obtain a first depth map of the to-be-estimated image; the first depth map of the to-be-estimated image including a first depth map of a former frame of the to-be-estimated image and a first depth map of a latter frame of the to-be-estimated image.

In this step, the above initial depth estimation model may include a depth encoding network and a depth decoding network. The depth encoding network may be configured to extract depth features from the to-be-estimated image. The depth decoding network may be configured to perform depth estimation-related feature extraction on the acquired depth features. Specifically, for the depth decoding network, a plurality of convolutional layers may be preset, and an upsampling layer may be arranged behind each convolutional layer. Depth estimation-related feature extraction is performed on the acquired depth features by using the plurality of convolutional layer and the upsampling layer. The above two frames of the to-be-estimated image may be a former frame of the to-be-estimated image and a latter frame of the to-be-estimated image divided according to a sampling time sequence. Correspondingly, the first depth map of the to-be-estimated image includes a first depth map of the former frame of the to-be-estimated image and a first depth map of the latter frame of the to-be-estimated image.

The performing, by using the preset initial depth estimation model, depth estimation on the two frames of the to-be-estimated image, to obtain the first depth map of the to-be-estimated image may be acquiring depth features of the to-be-estimated image by using the depth encoding network of the preset initial depth estimation model, then performing depth estimation-related feature extraction on the acquired depth features by using the depth decoding network of the preset initial depth estimation model, to obtain an inverse depth map of the to-be-estimated image, and finally performing reciprocal processing on the inverse depth map to obtain the first depth map of the to-be-estimated image. The inverse depth map of the to-be-estimated image is reciprocal of the depth map of the to-be-estimated image, and reciprocal processing may be performed on the inverse depth map to obtain the first depth map of the to-be-estimated image. It is to be noted that a size of the first depth map of the to-be-estimated image is related to a downsampling multiple in the depth encoding network of the initial depth estimation model and an upsampling multiple in the depth decoding network of the initial depth estimation model. If the downsampling multiple in the depth encoding network of the initial depth estimation model is equal to the upsampling multiple in the depth decoding network of the initial depth estimation model, the size of the first depth map of the to-be-estimated image is the same as a size of the to-be-estimated image. If the size of the first depth map of the to-be-estimated image is larger than the size of the to-be-estimated image, the first depth map of the to-be-estimated image may be scaled so that the size of the first depth map of the to-be-estimated image is consistent with the size of the to-be-estimated image. By use of the method including the step, the first depth map of the to-be-estimated image can be acquired, which facilitates subsequent calculation of a projection error by using the first depth map of the to-be-estimated image.

In step S220, point cloud estimation is performed, by using a preset initial point cloud estimation model, on two frames of a to-be-estimated millimeter-wave point cloud corresponding to the two frames of the to-be-estimated image, to obtain a dynamic point set and a first pose transformation result of the to-be-estimated millimeter-wave point cloud.

The above initial point cloud estimation model may include a scene flow prediction network and a pose estimation network. The scene flow prediction network may include a feature extraction layer to acquire a scene flow of the to-be-estimated millimeter-wave point cloud. The pose estimation network may reuse the feature extraction layer of the scene flow prediction network, and replace all network layers of the scene flow prediction network of the initial point cloud estimation model from an upsampling convolutional layer with N linear layers, and output of the final linear layer is a matrix with one row and six columns. The value of N and input and output of each linear layer may be preset. The pose estimation network may be configured to estimate a pose transformation result between the two frames of the to-be-estimated millimeter-wave point cloud. The performing, by using the preset initial point cloud estimation model, point cloud estimation on two frames of the to-be-estimated millimeter-wave point cloud corresponding to the two frames of the to-be-estimated image, to obtain the dynamic point set and the first pose transformation result of the to-be-estimated millimeter-wave point cloud may be acquiring a scene flow of the to-be-estimated millimeter-wave point cloud by using the scene flow prediction network of the preset initial point cloud estimation model. Then, dynamic points in the scene flow whose translation offsets are greater than or equal to one times a variance of an average translation offset are screened out according to a preset dynamic point screening condition, to obtain the dynamic point set of the to-be-estimated millimeter-wave point cloud. A matrix with one row and six columns of the to-be-estimated millimeter-wave point cloud may be acquired by using the pose estimation network of the preset initial point cloud estimation model, and then the matrix with one row and six columns is converted into a matrix with three rows and four columns by using a preset rotation formula, to obtain the first pose transformation result of the to-be-estimated millimeter-wave point cloud. The preset rotation formula may be a Rodrigues' rotation formula. The matrix with one row and six columns of the to-be-estimated millimeter-wave point cloud may be a matrix in which six columns respectively represent three angle values of Pitch, Yaw, and Roll and translation amounts in directions represented by three coordinate axes of X, Y, and Z. Pitch refers to a pitch angle, which is an angle between rise or bow and a horizontal plane, or may be interpreted as an angle of rotation along a Y axis of its own coordinate system (an X-axis forward coordinate system). Yaw refers to a yaw angle, which is an angle of rotation along a Z axis of the world coordinate system. Roll refers to a roll angle, which may be an angle between left or right tilt and the horizontal plane, or may be interpreted as an angle of rotation along an X axis of its own coordinate system (an X-axis forward coordinate system). For example, the above matrix A with one row and six columns may be expressed as:

A=[Pitch Yaw Roll X Y Z]

In the above matrix with three rows and four columns, the three rows may refer to three angle values of Pitch, Yaw, and Roll, and the four columns may refer to translation amounts in directions represented by three coordinate axes of X, Y, and Z, as well as a value of a radial velocity V. For example, the above matrix B with three rows and four columns may be expressed as:

$$B = [ \begin{matrix}{X}_{1} & {Y}_{1} & {Z}_{1} & {V}_{1} \\ {X}_{2} & {Y}_{2} & {Z}_{2} & {V}_{2} \\ {X}_{3} & {Y}_{3} & {Z}_{3} & {V}_{3}\end{matrix} ]$$

The above first pose transformation result may be a transformation matrix that converts the matrix with one row and six columns into the matrix with three rows and four columns. Through this step, the dynamic point set and the first pose transformation result of the to-be-estimated millimeter-wave point cloud can be acquired, which facilitates subsequent calculation of a pose estimation error or a depth error of a moving object by using the dynamic point set and the first pose transformation result.

In step S230, an external parameter transformation value of a camera is calculated based on the first pose transformation result; the first depth map of the former frame of the to-be-estimated image is projected to a viewing angle of the latter frame of the to-be-estimated image based on the external parameter transformation value of the camera and an internal parameter value of the camera, to obtain a second depth map of the latter frame of the to-be-estimated image; and a projection error between the first depth map of the latter frame of the to-be-estimated image and the second depth map of the latter frame of the to-be-estimated image is calculated according to a preset projection error calculation manner.

The calculating the external parameter transformation value of the camera based on the first pose transformation result may be obtaining the external parameter transformation value of the camera corresponding to the two frames of the to-be-estimated image may be obtained based on the first pose transformation result and a preset external parameter value from millimeter-wave radar to the camera. For example, a specific calculation formula of an external parameter transformation value TC_{T-1→T} of the camera corresponding to the to-be-estimated image at time T−1 to the to-be-estimated image at time T is:

$${TC}_{T - 1 \to T} = {T}_{R \to C}^{- 1} {TR}_{T - 1 \to T} {T}_{R \to C}$$

where T_{R→C} denotes an external parameter value from the millimeter-wave radar to the camera, and TR_{T-1→T} denotes a first pose transformation result from the to-be-estimated millimeter-wave point cloud at time T−1 to the to-be-estimated millimeter-wave point cloud at time T.

The obtaining the second depth map of the latter frame of the to-be-estimated image may be projecting the first depth map of the former frame of the to-be-estimated image to the viewing angle of the latter frame of the to-be-estimated image based on the external parameter transformation value of the camera and the internal parameter value of the camera, to obtain the second depth map of the latter frame of the to-be-estimated image based on a projection result. For example, a first depth map D_{T-1} of the to-be-estimated image at time T−1 may be projected to a viewing angle of the to-be-estimated image at time T based on the external parameter transformation value TC_{T-1→T} of the camera corresponding to the to-be-estimated image at time T−1 to the to-be-estimated image at time T and the internal parameter value of the camera, and a second depth map D_{T-1→T} of the to-be-estimated image at time T is obtained based on a projection result. A calculation formula of the second depth map D_{T-1→T} of the to-be-estimated image at time T is as follows:

$${D}_{T - 1 \to T} = {D}_{T - 1} {TC}_{T - 1 \to T}^{- 1}$$

The calculating the projection error between the first depth map of the latter frame of the to-be-estimated image and the second depth map of the latter frame of the to-be-estimated image according to the preset projection error calculation manner may be calculating a loss of a projection error between the first depth map of the latter frame of the to-be-estimated image and the second depth map of the former frame of the to-be-estimated image by using an SSIM loss function. For example, a calculation formula for calculating a projection error between the first depth map D_{T} of the to-be-estimated image at time T and the second depth map D_{T-1→T} of the to-be-estimated image at time T by using the SSIM loss function is:

$${L}_{1} = \frac{\partial }{2} ( 1 - SSIM ( {D}_{T} , {D}_{T - 1 \to T} ) ) + ( 1 - \partial ) {‖ {D}_{T} - {D}_{T - 1 \to T} ‖}_{1}$$

where ∂ denotes a preset parameter.

In step S240, overall pose transformation estimation is performed on the two frames of the to-be-estimated millimeter-wave point cloud by using a preset estimation algorithm, to obtain a second pose transformation result of overall pose transformation of the to-be-estimated millimeter-wave point cloud; and a pose estimation error between the first pose transformation result and the second pose transformation result is obtained based on the first pose transformation result and the second pose transformation result according to a preset pose estimation error calculation manner.

In this step, the performing, by using the preset estimation algorithm, overall pose transformation estimation on the two frames of the to-be-estimated millimeter-wave point cloud, to obtain the second pose transformation result of overall pose transformation of the to-be-estimated millimeter-wave point cloud may be performing, by using an ICP algorithm, overall pose transformation estimation on the two frames of the to-be-estimated millimeter-wave point cloud, to obtain the second pose transformation result of overall pose transformation of the to-be-estimated millimeter-wave point cloud. The obtaining the pose estimation error between the first pose transformation result and the second pose transformation result according to the preset pose estimation error calculation manner may be calculating the pose estimation error between the first pose transformation result and the second pose transformation result according to the preset pose estimation error calculation manner. A calculation formula of the pose estimation error L₂ between the first pose transformation result and the second pose transformation result is:

$${L}_{2} = {‖ {TR}_{1} - {TR}_{2} ‖}_{2}^{2}$$

where TR₁ denotes the first pose transformation result, and TR₂ denotes the second pose transformation result.

In step S250, a depth error of a moving object in the two frames of the to-be-estimated image is calculated based on the first depth map and the dynamic point set according to a preset moving object depth error calculation manner.

The calculating the depth error of the moving object in the two frames of the to-be-estimated image according to the preset moving object depth error calculation manner may be calculating the depth error of the moving object in the two frames of the to-be-estimated image according to a probability that any point pair p and q in the two frames of the millimeter-wave point cloud corresponding to the two frames of the to-be-estimated image is from a same obstacle, whether a three-dimensional vector formed at the point q is consistent with an overall translation manner of the two frames of the millimeter-wave point cloud, and depth values of the first depth maps of the two frames of the to-be-estimated image at positions corresponding to the two frames of the millimeter-wave point cloud where the point pair p and q is located. A calculation formula of the depth error L₃ of the moving object in the two frames of the to-be-estimated image is:

$${L}_{3} = {\sum }_{p ∈ {RD}_{T} , q ∈ {RD}_{T - 1}} Sim ( p , q ) \cdot π ( cos ( {Loc}_{q} , {TR}_{T - 1 \to T} [ : , 3 ] ) ) \cdot π ( {D}_{T} ( p ) < {D}_{T - 1} ( q ) )$$

where RD_{T-1} denotes a dynamic point set at time T−1, RD_{T} denotes a dynamic point set at time T, p and q denotes any point pair in RD_{T-1} and RD_{T}, Sim (p,q) denotes a probability that p and q are from a same obstacle, Loc_{q} denotes three-dimensional space coordinates of the point q with a millimeter wave as an origin, TR_{T-1→T} denotes a first pose transformation result of the to-be-estimated millimeter-wave point cloud from time T−1 to time T, D_{T}(p) denotes a depth value of the point p in a first depth map of the to-be-estimated image at time T, and D_{T-1}(q) denotes a depth value of the point q in a first depth map of the to-be-estimated image at time T−1.

A calculation formula of Sim (p,q) is as follows:

$$Sim ( p , q ) = {\sum }_{p ∈ {RD}_{T} , q ∈ {RD}_{T - 1}} \frac{{Loc}_{p} \cdot {Loc}_{q}}{{‖ {Loc}_{p} ‖}^{2} + {‖ {Loc}_{q} ‖}^{2} - {Loc}_{p} \cdot {Loc}_{q}} \cdot ( \frac{{V}_{p}}{{V}_{p} + {V}_{q}} \cdot \frac{{V}_{q}}{{V}_{p} + {V}_{q}} )$$

where Locₚ denotes three-dimensional space coordinates of p, Loc_{q} denotes three-dimensional space coordinates of q, and Vₚ and V_{q} are scalars at the point P and the point q, which denote radial velocities at the point p and the point q.

π(cos(Loc_{q}, TR_{T-1→T}[:,3])) denotes an indicator function. When the three-dimensional vector formed at the point q is consistent with an overall translation direction of former and latter frames of the millimeter-wave point cloud, the value of the indicator function is 1. Otherwise, the value of the indicator function is 0.

π(D_{T}(p)<D_{T-1}(q)) denotes an indicator function. When the depth value of p in the first depth map of the to-be-estimated image at time T is less than the depth value of q in the first depth map of the to-be-estimated image at time T−1, the value of the indicator function is 1. Otherwise, the value of the indicator function is 0.

In step S260, an overall training loss of the to-be-estimated image is obtained according to the projection error between the first depth map of the latter frame of the to-be-estimated image and the second depth map of the latter frame of the to-be-estimated image, the pose estimation error between the first pose transformation result and the second pose transformation result, and the depth error of the moving object in the two frames of the to-be-estimated image, and the initial depth estimation model and the initial point cloud estimation model are trained by using the overall training loss, until the initial depth estimation model and the initial point cloud estimation model converge, to obtain a complete depth estimation model for monocular image depth estimation.

In this step, a calculation formula of obtaining the overall training loss L of the to-be-estimated image according to the projection error between the first depth map of the latter frame of the to-be-estimated image and the second depth map of the latter frame of the to-be-estimated image, the pose estimation error between the first pose transformation result and the second pose transformation result, and the depth error of the moving object in the two frames of the to-be-estimated image is:

$$L = {L}_{1} + β \cdot {L}_{2} + ( 1 - β ) \cdot {L}_{3}$$

where

$$β = 1 - \frac{ep}{Max\_epoch} ,$$

ep denotes a current training round, and Max_epoch denotes a maximum training round.

A convergence condition of the initial depth estimation model and the initial point cloud estimation model may be the overall training loss L of the to-be-estimated image reaching a preset threshold or a number of times of training of the initial depth estimation model and the initial point cloud estimation model reaching a preset threshold.

In step S270, monocular image depth estimation is performed on the to-be-estimated image based on the complete depth estimation model.

Through step S210 to step S270 above, the first depth map of the to-be-estimated image is obtained by using the preset initial depth estimation model, and the dynamic point set and the first pose transformation result of the to-be-estimated millimeter-wave point cloud are obtained by using the preset initial point cloud estimation model. Then, the first depth map of the latter frame of the to-be-estimated image is calculated by using the preset algorithm, to obtain the second depth map of the latter frame of the to-be-estimated image, and the projection error between the first depth map of the former frame of the to-be-estimated image and the second depth map of the latter frame of the to-be-estimated image is calculated. Pose transformation calculation is performed on the two frames of the to-be-estimated millimeter-wave point cloud to obtain the second pose transformation result, the pose estimation error between the first pose transformation result and the second pose transformation result is calculated, and finally the depth error of the moving object in the two frames of the to-be-estimated image is calculated. Then, the projection error, the pose estimation error, and the depth error of the moving object are fed back to the overall training loss to train the initial depth estimation model. In this way, the moving object in the image can be taken into account to obtain an accurate and complete depth estimation model, thereby ensuring stability of implementation of the depth estimation result of the image by using the complete depth estimation model and solving the problem in the related art that stability of the depth estimation result of the image cannot be guaranteed.

In an embodiment, prior to step S210 of performing, by using the preset initial depth estimation model, depth estimation on the two frames of the to-be-estimated image, to obtain the first depth map of the to-be-estimated image, the method includes the following step.

In step S202, an operation of subtracting a mean value and dividing by a variance is performed on two frames of a to-be-estimated original image to generate two frames of a first image.

In this step, the above operation of subtracting a mean value and dividing by a variance may be an operation of subtracting a mean value and dividing by a variance on the two frames of the to-be-estimated original image according to a channel.

In step S204, the two frames of the first image are scaled to a preset size by using a preset scaling method, to obtain the two frames of the scaled to-be-estimated image.

The preset scaling method may be a method capable of scaling an image such as a nearest neighbor scaling method, a bilinear scaling method, or a bicubic scaling method. It is to be noted that the first image may be scaled by using one or more of the above methods or other methods for image scaling, which is not specifically limited herein.

Through step S202 to step S204 above, the operation of subtracting a mean value and dividing by a variance is performed on the two frames of the to-be-estimated original image to generate the two frames of the first image, and then the two frames of the first image are scaled to the preset size to obtain the to-be-estimated image, which can improve efficiency of depth estimation on the to-be-estimated image by using the initial depth estimation model.

This embodiment is described and illustrated below through optional embodiments.

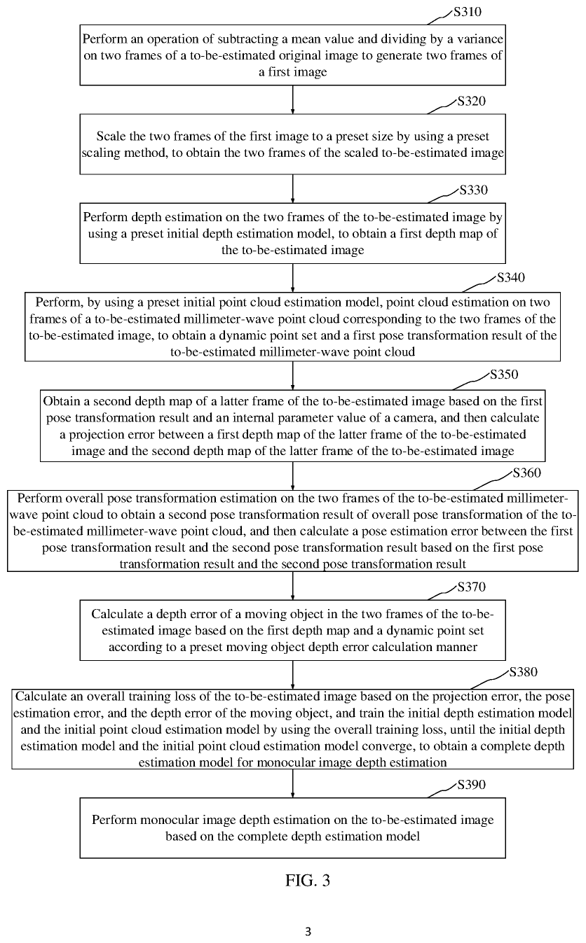

FIG. 3 is a flowchart of a monocular image depth estimation method according to an optional embodiment of the present disclosure. As shown in FIG. 3, the monocular image depth estimation method includes step S310 to step S390 below.

In step S310, an operation of subtracting a mean value and dividing by a variance is performed on two frames of a to-be-estimated original image to generate two frames of a first image.

In step S320, the two frames of the first image are scaled to a preset size by using a preset scaling method, to obtain the two frames of the scaled to-be-estimated image.

In step S330, depth estimation is performed on the two frames of the to-be-estimated image by using a preset initial depth estimation model, to obtain a first depth map of the to-be-estimated image.

In step S340, point cloud estimation is performed, by using a preset initial point cloud estimation model, on two frames of a to-be-estimated millimeter-wave point cloud corresponding to the two frames of the to-be-estimated image, to obtain a dynamic point set and a first pose transformation result of the to-be-estimated millimeter-wave point cloud.

In step S350, a second depth map of a latter frame of the to-be-estimated image is obtained based on the first pose transformation result and an internal parameter value of a camera, and then a projection error between a first depth map of the latter frame of the to-be-estimated image and the second depth map of the latter frame of the to-be-estimated image is calculated.

In step S360, overall pose transformation estimation is performed on the two frames of the to-be-estimated millimeter-wave point cloud to obtain a second pose transformation result of overall pose transformation of the to-be-estimated millimeter-wave point cloud, and then a pose estimation error between the first pose transformation result and the second pose transformation result is calculated based on the first pose transformation result and the second pose transformation result.

In step S370, a depth error of a moving object in the two frames of the to-be-estimated image is calculated based on the first depth map and a dynamic point set according to a preset moving object depth error calculation manner.

In step S380, an overall training loss of the to-be-estimated image is calculated based on the projection error, the pose estimation error, and the depth error of the moving object, and the initial depth estimation model and the initial point cloud estimation model are trained by using the overall training loss, until the initial depth estimation model and the initial point cloud estimation model converge, to obtain a complete depth estimation model for monocular image depth estimation.

In step S390, monocular image depth estimation is performed on the to-be-estimated image based on the complete depth estimation model.

Through step S310 to step S390 above, the operation of subtracting a mean value and dividing by a variance is performed on the two frames of the to-be-estimated original image to generate the two frames of the first image, and then the two frames of the first image are scaled to the preset size by using the preset scaling method, to obtain the two frames of the scaled to-be-estimated image. Then, the first depth map of the to-be-estimated image is obtained by using the preset initial depth estimation model, and the dynamic point set and the first pose transformation result of the to-be-estimated millimeter-wave point cloud are obtained by using the preset initial point cloud estimation model. Then, the first depth map of the latter frame of the to-be-estimated image is calculated by using the preset algorithm, to obtain the second depth map of the latter frame of the to-be-estimated image, and the projection error between the first depth map of the former frame of the to-be-estimated image and the second depth map of the latter frame of the to-be-estimated image is calculated. Pose transformation calculation is performed on the two frames of the to-be-estimated millimeter-wave point cloud to obtain the second pose transformation result, the pose estimation error between the first pose transformation result and the second pose transformation result is calculated, and finally the depth error of the moving object in the two frames of the to-be-estimated image is calculated. Then, the projection error, the pose estimation error, and the depth error of the moving object are fed back to the overall training loss to train the initial depth estimation model. In this way, the moving object in the image can be taken into account to obtain an accurate and complete depth estimation model, thereby ensuring stability of implementation of the depth estimation result of the image by using the complete depth estimation model and solving the problem in the related art that stability of the depth estimation result of the image cannot be guaranteed.

It should be understood that, although the steps in the flowcharts involved in the above embodiments are displayed in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts involved in the above embodiments may include a plurality of steps or a plurality of stages. Such steps or stages are not necessarily performed at a same moment and may be performed at different moments. The steps or stages are not necessarily performed in sequence, and the steps or stages and at least some of other steps or steps or stages of other steps may be performed in turn or alternately.

Based on a same inventive concept, a monocular image depth estimation apparatus 400 is further provided in this embodiment. The apparatus is configured to implement the above embodiments and optional implementations. Those that have been described will not be described again. As used below, the terms “module”, “unit”, “subunit”, and the like may be combinations of software and/or hardware that can implement predetermined functions. The apparatus described in the following embodiments may be implemented by software, but implementation by hardware or by a combination of software and hardware is also possible and conceived.

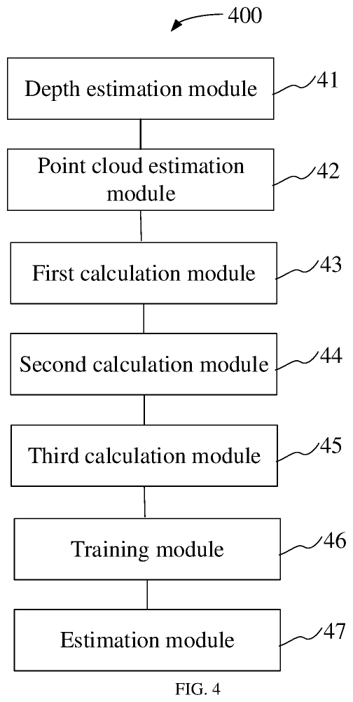

In an embodiment, FIG. 4 is a structural block diagram of a monocular image depth estimation apparatus 400 according to an embodiment of the present disclosure. As shown in FIG. 4, the monocular image depth estimation apparatus 400 includes:
a depth estimation module 41 configured to perform, by using a preset initial depth estimation model, depth estimation on two frames of a to-be-estimated image, to obtain a first depth map of the to-be-estimated image; the first depth map of the to-be-estimated image including a first depth map of a former frame of the to-be-estimated image and a first depth map of a latter frame of the to-be-estimated image;
a point cloud estimation module 42 configured to perform, by using a preset initial point cloud estimation model, point cloud estimation on two frames of a to-be-estimated millimeter-wave point cloud corresponding to the two frames of the to-be-estimated image, to obtain a dynamic point set and a first pose transformation result of the to-be-estimated millimeter-wave point cloud;
a first calculation module 43 configured to calculate an external parameter transformation value of a camera based on the first pose transformation result; projecting the first depth map of the former frame of the to-be-estimated image to a viewing angle of the latter frame of the to-be-estimated image based on the external parameter transformation value of the camera and an internal parameter value of the camera, to obtain a second depth map of the latter frame of the to-be-estimated image; and calculate a projection error between the first depth map of the latter frame of the to-be-estimated image and the second depth map of the latter frame of the to-be-estimated image according to a preset projection error calculation manner;
a second calculation module 44 configured to perform, by using a preset estimation algorithm, overall pose transformation estimation on the two frames of the to-be-estimated millimeter-wave point cloud, to obtain a second pose transformation result of overall pose transformation of the to-be-estimated millimeter-wave point cloud; and obtain a pose estimation error between the first pose transformation result and the second pose transformation result based on the first pose transformation result and the second pose transformation result according to a preset pose estimation error calculation manner;
a third calculation module 45 configured to calculate a depth error of a moving object in the two frames of the to-be-estimated image based on the first depth map and the dynamic point set according to a preset moving object depth error calculation manner;
a training module 46 configured to obtain an overall training loss of the to-be-estimated image according to the projection error between the first depth map of the latter frame of the to-be-estimated image and the second depth map of the latter frame of the to-be-estimated image, the pose estimation error between the first pose transformation result and the second pose transformation result, and the depth error of the moving object in the two frames of the to-be-estimated image, and train the initial depth estimation model and the initial point cloud estimation model by using the overall training loss, until the initial depth estimation model and the initial point cloud estimation model converge, to obtain a complete depth estimation model for monocular image depth estimation; and
an estimation module 47 configured to perform monocular image depth estimation on the to-be-estimated image based on the complete depth estimation model.

According to the above monocular image depth estimation apparatus 400, the first depth map of the to-be-estimated image is obtained by using the preset initial depth estimation model, and the dynamic point set and the first pose transformation result of the to-be-estimated millimeter-wave point cloud are obtained by using the preset initial point cloud estimation model. Then, the second depth map of the latter frame of the to-be-estimated image is calculated by using the preset algorithm, to obtain the second depth map of the latter frame of the to-be-estimated image, and the projection error between the first depth map of the former frame of the to-be-estimated image and the second depth map of the latter frame of the to-be-estimated image is calculated. Pose transformation calculation is performed on the two frames of the to-be-estimated millimeter-wave point cloud to obtain the second pose transformation result, the pose estimation error between the first pose transformation result and the second pose transformation result is calculated, and finally the depth error of the moving object in the two frames of the to-be-estimated image is calculated. Then, the projection error, the pose estimation error, and the depth error of the moving object are fed back to the overall training loss to train the initial depth estimation model. In this way, the moving object in the image can be taken into account to obtain an accurate and complete depth estimation model, thereby ensuring stability of implementation of the depth estimation result of the image by using the complete depth estimation model and solving the problem in the related art that stability of the depth estimation result of the image cannot be guaranteed.

It is to be noted that the above modules may be functional modules or program modules, and may be implemented by software or hardware. For modules implemented by hardware, the above modules may be located in a same processor; or the above modules may alternatively be located in different processors in any combination.

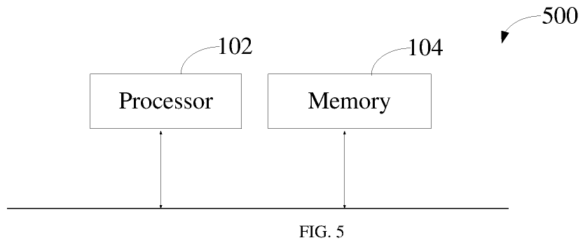

In an embodiment, FIG. 5 is a structural block diagram of a computer device according to some embodiments. As shown in FIG. 5, a computer device 500 is provided, including a memory 104 and a processor 102. The memory 104 stores a computer program. The processor 102 is configured to execute the computer program to implement any one of the monocular image depth estimation methods in the above embodiments.

It is to be noted that user information (including, but not limited to, user equipment information, user personal information, and the like) and data (including, but not limited to, data for analysis, stored data, displayed data, and the like) involved in the present disclosure are information and data authorized by the user or fully authorized by all parties.

Those of ordinary skill in the art may understand that some or all flows in the methods in the foregoing embodiments may be implemented by a computer program instructing related hardware, the computer program may be stored in a non-transitory computer-readable storage medium, and when the computer program is executed, the processes in the foregoing method embodiments may be implemented. Any reference to the memory, the database, or other media used in the embodiments provided in the present disclosure may include at least one of a non-transitory memory and a transitory memory. The non-transitory memory may include a Read-Only Memory (ROM), a magnetic tape, a floppy disk, a flash memory, an optical memory, a high-density embedded non-transitory memory, a resistive random access memory (ReRAM), a Magnetoresistive Random Access Memory (MRAM), a Ferroelectric Random Access Memory (FRAM), a Phase Change Memory (PCM), a graphene memory, and the like. The transitory memory may include a Random Access Memory (RAM) or an external cache memory. By way of illustration instead of limitation, the RAM is available in a variety of forms, such as a static RAM (SRAM) or a dynamic RAM (DRAM). The database involved in the embodiments provided in the present disclosure may include at least one of a relational database and a non-relational database. The non-relational database may include a blockchain-based distributed database and the like, but is not limited thereto. The processor involved in the embodiments provided in the present disclosure may be a general-purpose processor, a central processing unit, a graphics processor, a digital signal processor, a programmable logic device, a data processing logic device based on quantum computing, and the like, and is not limited thereto.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, which are described specifically and in detail, and therefore cannot be construed as a limitation on the patent scope of the present disclosure. It should be pointed out that those of ordinary skill in the art may also make several changes and improvements without departing from the ideas of the present disclosure, all of which fall within the protection scope of the present disclosure. Therefore, the protection scope of the present disclosure shall be subject to the appended claims.

What is claimed is:

1. A monocular image depth estimation method, comprising:
performing, by using a preset initial depth estimation model, depth estimation on two frames of a to-be-estimated image, to obtain a first depth map of the to-be-estimated image; the first depth map of the to-be-estimated image comprising a first depth map of a former frame of the to-be-estimated image and a first depth map of a latter frame of the to-be-estimated image;
performing, by using a preset initial point cloud estimation model, point cloud estimation on two frames of a to-be-estimated millimeter-wave point cloud corresponding to the two frames of the to-be-estimated image, to obtain a dynamic point set and a first pose transformation result of the to-be-estimated millimeter-wave point cloud;
calculating an external parameter transformation value of a camera based on the first pose transformation result; projecting the first depth map of the former frame of the to-be-estimated image to a viewing angle of the latter frame of the to-be-estimated image based on the external parameter transformation value of the camera and an internal parameter value of the camera, to obtain a second depth map of the latter frame of the to-be-estimated image; and calculating a projection error between the first depth map of the latter frame of the to-be-estimated image and the second depth map of the latter frame of the to-be-estimated image according to a preset projection error calculation manner;
performing, by using a preset estimation algorithm, overall pose transformation estimation on the two frames of the to-be-estimated millimeter-wave point cloud, to obtain a second pose transformation result of overall pose transformation of the to-be-estimated millimeter-wave point cloud; and obtaining a pose estimation error between the first pose transformation result and the second pose transformation result based on the first pose transformation result and the second pose transformation result according to a preset pose estimation error calculation manner;
calculating a depth error of a moving object in the two frames of the to-be-estimated image based on the first depth map and the dynamic point set according to a preset moving object depth error calculation manner;
obtaining an overall training loss of the to-be-estimated image according to the projection error between the first depth map of the latter frame of the to-be-estimated image and the second depth map of the latter frame of the to-be-estimated image, the pose estimation error between the first pose transformation result and the second pose transformation result, and the depth error of the moving object in the two frames of the to-be-estimated image, and training the initial depth estimation model and the initial point cloud estimation model by using the overall training loss, until the initial depth estimation model and the initial point cloud estimation model converge, to obtain a complete depth estimation model for monocular image depth estimation;
performing monocular image depth estimation on the to-be-estimated image based on the complete depth estimation model.

2. The monocular image depth estimation method of claim 1, further comprising: prior to the performing, by using the preset initial depth estimation model, depth estimation on the two frames of the to-be-estimated image, to obtain the first depth map of the to-be-estimated image,
performing an operation of subtracting a mean value and dividing by a variance on two frames of a to-be-estimated original image to generate two frames of a first image; and
scaling the two frames of the first image to a preset size by using a preset scaling method, to obtain the two frames of the scaled to-be-estimated image.

3. The monocular image depth estimation method of claim 1, wherein the performing, by using the preset initial depth estimation model, depth estimation on the two frames of the to-be-estimated image, to obtain the first depth map of the to-be-estimated image comprises:
acquiring depth features of the to-be-estimated image by using a depth encoding network of the preset initial depth estimation model;
performing depth estimation-related feature extraction on the acquired depth features by using a depth decoding network of the preset initial depth estimation model, to obtain an inverse depth map of the to-be-estimated image;
performing reciprocal processing on the inverse depth map to obtain the first depth map of the to-be-estimated image.

4. The monocular image depth estimation method of claim 1, wherein the performing, by using the preset initial point cloud estimation model, point cloud estimation on the two frames of the to-be-estimated millimeter-wave point cloud corresponding to the two frames of the to-be-estimated image, to obtain the dynamic point set and the first pose transformation result of the to-be-estimated millimeter-wave point cloud comprises:
acquiring a scene flow of the to-be-estimated millimeter-wave point cloud by using a scene flow prediction network of the preset initial point cloud estimation model;
screening out, according to a preset dynamic point screening condition, dynamic points in the scene flow whose translation offsets are greater than or equal to one times a variance of an average translation offset, to obtain the dynamic point set of the to-be-estimated millimeter-wave point cloud;
acquiring a matrix with one row and six columns of the to-be-estimated millimeter-wave point cloud by using a pose estimation network of the preset initial point cloud estimation model;
converting the matrix with one row and six columns into a matrix with three rows and four columns by using a preset rotation formula, to obtain the first pose transformation result of the to-be-estimated millimeter-wave point cloud.

5. The monocular image depth estimation method of claim 1, wherein the calculating the external parameter transformation value of the camera based on the first pose transformation result; projecting the first depth map of the former frame of the to-be-estimated image to the viewing angle of the latter frame of the to-be-estimated image based on the external parameter transformation value of the camera and the internal parameter value of the camera, to obtain the second depth map of the latter frame of the to-be-estimated image comprises:
obtaining the external parameter transformation value of the camera corresponding to the two frames of the to-be-estimated image based on the first pose transformation result and a preset external parameter value from millimeter-wave radar to the camera;
projecting the first depth map of the former frame of the to-be-estimated image to the viewing angle of the latter frame of the to-be-estimated image based on the external parameter transformation value of the camera and the internal parameter value of the camera, to obtain the second depth map of the latter frame of the to-be-estimated image based on a projection result.

6. The monocular image depth estimation method of claim 1, wherein a calculation formula of the projection error L₁ between the first depth map of the latter frame of the to-be-estimated image and the second depth map of the latter frame of the to-be-estimated image is:
$${L}_{1} = \frac{\partial }{2} ( 1 - SSIM ( {D}_{T} , {D}_{T - 1 \to T} ) ) + ( 1 - \partial ) {‖ {D}_{T} - {D}_{T - 1 \to T} ‖}_{1}$$
where D_{T} denotes a first depth map of the to-be-estimated image at time T, D_{T-1→T} denotes a second depth map of the to-be-estimated image at time T obtained by projecting a first depth map of the to-be-estimated image at time T−1 to a viewing angle of the to-be-estimated image at time T, Structure Similarity Index Measure (SSIM) denotes a loss of a projection error between the first depth map of the to-be-estimated image at time T and the second depth map of the to-be-estimated image at time T calculated by using an SSIM loss function, and ∂ denotes a preset parameter.

7. The monocular image depth estimation method of claim 1, wherein the performing, by using the preset estimation algorithm, overall pose transformation estimation on the two frames of the to-be-estimated millimeter-wave point cloud, to obtain the second pose transformation result of overall pose transformation of the to-be-estimated millimeter-wave point cloud comprises:
performing, by using an Iterative Closest Point (ICP) algorithm, overall pose transformation estimation on the two frames of the to-be-estimated millimeter-wave point cloud, to obtain the second pose transformation result of overall pose transformation of the to-be-estimated millimeter-wave point cloud.

8. The monocular image depth estimation method of claim 1, wherein a calculation formula of the pose estimation error L₂ between the first pose transformation result and the second pose transformation result is:
$${L}_{2} = {‖ {TR}_{1} - {TR}_{2} ‖}_{2}^{2}$$
where TR₁ denotes the first pose transformation result, and TR₂ denotes the second pose transformation result.

9. The monocular image depth estimation method of claim 1, wherein a calculation formula of the depth error L₃ of the moving object in the two frames of the to-be-estimated image is:
$${L}_{3} = {\sum }_{p ∈ {RD}_{T} , q ∈ {RD}_{T - 1}} Sim ( p , q ) \cdot π ( cos ( {Loc}_{q} , {TR}_{T - 1 \to T} [ : , 3 ] ) ) \cdot π ( {D}_{T} ( p ) < {D}_{T - 1} ( q ) )$$
where RD_{T-1} denotes a dynamic point set at time T−1, RD_{T} denotes a dynamic point set at time T, p and q denotes any point pair in RD_{T-1} and RD_{T}, Sim (p,q) denotes a probability that p and q are from a same obstacle, π(cos(Loc_{q}, TR_{T-1→T} [:,3])) denotes an indicator function, Loc_{q} denotes three-dimensional space coordinates of a point q, TR_{T-1→T} denotes a first pose transformation result of the to-be-estimated millimeter-wave point cloud from time T−1 to time T, π(D_{T}(p)<D_{T-1}(q)) denotes an indicator function, D_{T}(p) denotes a depth value of p in a first depth map of the to-be-estimated image at time T, and D_{T-1}(q) denotes a depth value of q in a first depth map of the to-be-estimated image at time T−1.

10. The monocular image depth estimation method of claim 1, wherein a calculation formula of the overall training loss L of the to-be-estimated image is:
$$L = {L}_{1} + β \cdot {L}_{2} + ( 1 - β ) \cdot {L}_{3}$$
where
$$β = 1 - \frac{ep}{Max\_epoch} ,$$
ep denotes a current training round, and Max_epoch denotes a maximum training round.

11. A monocular image depth estimation apparatus, comprising:
a depth estimation module configured to perform, by using a preset initial depth estimation model, depth estimation on two frames of a to-be-estimated image, to obtain a first depth map of the to-be-estimated image; the first depth map of the to-be-estimated image comprising a first depth map of a former frame of the to-be-estimated image and a first depth map of a latter frame of the to-be-estimated image;
a point cloud estimation module configured to perform, by using a preset initial point cloud estimation model, point cloud estimation on two frames of a to-be-estimated millimeter-wave point cloud corresponding to the two frames of the to-be-estimated image, to obtain a dynamic point set and a first pose transformation result of the to-be-estimated millimeter-wave point cloud;
a first calculation module configured to calculate an external parameter transformation value of a camera based on the first pose transformation result; project the first depth map of the former frame of the to-be-estimated image to a viewing angle of the latter frame of the to-be-estimated image based on the external parameter transformation value of the camera and an internal parameter value of the camera, to obtain a second depth map of the latter frame of the to-be-estimated image; and calculate a projection error between the first depth map of the latter frame of the to-be-estimated image and the second depth map of the latter frame of the to-be-estimated image according to a preset projection error calculation manner;
a second calculation module configured to perform, by using a preset estimation algorithm, overall pose transformation estimation on the two frames of the to-be-estimated millimeter-wave point cloud, to obtain a second pose transformation result of overall pose transformation of the to-be-estimated millimeter-wave point cloud; and obtain a pose estimation error between the first pose transformation result and the second pose transformation result based on the first pose transformation result and the second pose transformation result according to a preset pose estimation error calculation manner;
a third calculation module configured to calculate a depth error of a moving object in the two frames of the to-be-estimated image based on the first depth map and the dynamic point set according to a preset moving object depth error calculation manner;
a training module configured to obtain an overall training loss of the to-be-estimated image according to the projection error between the first depth map of the latter frame of the to-be-estimated image and the second depth map of the latter frame of the to-be-estimated image, the pose estimation error between the first pose transformation result and the second pose transformation result, and the depth error of the moving object in the two frames of the to-be-estimated image, and train the initial depth estimation model and the initial point cloud estimation model by using the overall training loss, until the initial depth estimation model and the initial point cloud estimation model converge, to obtain a complete depth estimation model for monocular image depth estimation; and
an estimation module configured to perform monocular image depth estimation on the to-be-estimated image based on the complete depth estimation model.

12. A computer device, comprising a memory and a processor, the memory storing a computer program, wherein the processor, when executing the computer program, implements steps of the monocular image depth estimation method in claim 1.
